(19) United States
(12) Patent Application Publication
(10) Pub. No.: US 2009/0184146 A1
(43) Pub. Date: Jul. 23, 2009

(54) SHOPPING CART ORGANIZER

(76) Inventor: Linda A. DICCIANNI, Monroe Township, NJ (US)

Correspondence Address: Diane Dunn McKay, Esq.;Porzio, Bromberg & Newman, P.C., Suite 201, 29 Thanet Road, Princeton, NJ, 08540, US

(21) Appl. No.: 12/350,999

(22) Filed: Jan. 9, 2009

Related U.S. Application Data
(60) Provisional application No. 61/010,856, filed on Jan. 11, 2008.

(51) Int. Cl. B60R 9/00; D05B 97/00

(52) U.S. Cl. 224/411; 112/475.08

(57) ABSTRACT

The present invention provides a sanitary shopping cart organizer device in which a material is attached to a handle of a shopping cart. The material provides a barrier to germs or dirt on the handle or the shopping cart. Preferably, the material is a durable material, such as a backpack material. The material can include a coating to provide waterproofing or wiping down of liquids or dirt from the material. In one embodiment, the material is formed of fabric to allow machine washing and drying and to provide comfort to a user such that the temperature of the handle is not felt by the user. The device can be expeditiously attached to the handle of the shopping cart, for example with a VELCRO® material. One or more pockets can be formed in a front surface of the device. The pockets can be used to hold, for example, a shopping list, coupons, pad, pen, eyeglasses, key and the like. The device can be formed of a single piece of material.

### CROSS REFERENCE TO RELATED APPLICATION

This application claims the benefit of U.S. Provisional Patent Application No. 61/010,856, filed Jan. 11, 2008, the entirety of which is hereby incorporated by reference into this application.

### BACKGROUND OF THE INVENTION

1. Field of the Invention

The present invention relates to a sanitary shopping cart organizer in which the device protects user and child riders from unsanitary shopping cart handles and provides easily accessible pockets for organizing items during shopping.

2. Description of Related Art

Protection sleeves for shopping chart handles are known. U.S. Pat. No. 5,722,672 describes a removable protective cover. A T-shaped member is wrapped around a vertical face of the cart.

U.S. Pat. No. 4,512,504 describes a shopping cart organizer attached to a portion of a cart handle. The organizer includes a sleeve for receiving a pen, a plate having a spring clip for retaining papers and divided compartments.

It is desirable to provide a device for protection of the length of the shopping cart handle which also contains one or more pockets for organizing materials formed of a single piece of material.

### SUMMARY OF THE INVENTION

The present invention provides a sanitary shopping cart organizer device in which a material is attached to a handle of a shopping cart. The material provides a barrier to germs or dirt on the handle or the shopping cart. Preferably, the material is a durable material, such as a backpack material. The material can include a coating to provide waterproofing or wiping down of liquids or dirt from the material. In one embodiment the material is formed of fabric to allow machine washing and drying and to provide comfort to a user such that the temperature of the handle is not felt by the user. Typically, in the winter, the shopping cart handle is cold and in the summer, the shopping cart handle is warm. The device can be expeditiously attached to the handle of the shopping cart, for example with a VELCRO® material. One or more pockets can be formed in a front surface of the device. The pockets can be used to hold, for example, a shopping list, coupons, pad, pen, eyeglasses, key and the like. The device can be formed of a single piece of material to provide low manufacturing costs.

The invention will be more fully described by reference to the following drawings.

### BRIEF DESCRIPTION OF THE DRAWINGS

FIG. 1 is a plan view of a front of a sanitary shopping cart organizer device in an open position in accordance with the teachings of the present invention.

FIG. 2 is a plan view of a rear of the sanitary shopping cart organizer device in an open position.

FIG. 3 is a front elevational view of the sanitary shopping cart organizer device upon attachment to a shopping cart handle.

FIG. 4 is a rear elevational view of the sanitary shopping cart organizer device upon attachment to a shopping cart handle.

FIG. 5 is a perspective view of the sanitary shopping cart organizer including receipt of the desired objects.

FIG. 6 is a perspective view of the sanitary shopping cart organizer device during use on a shopping cart.

### DETAILED DESCRIPTION

Reference will now be made in greater detail to a preferred embodiment of the invention, an example of which is illustrated in the accompanying drawings. Wherever possible, the same reference numerals will be used throughout the drawings and the description to refer to the same or like parts.

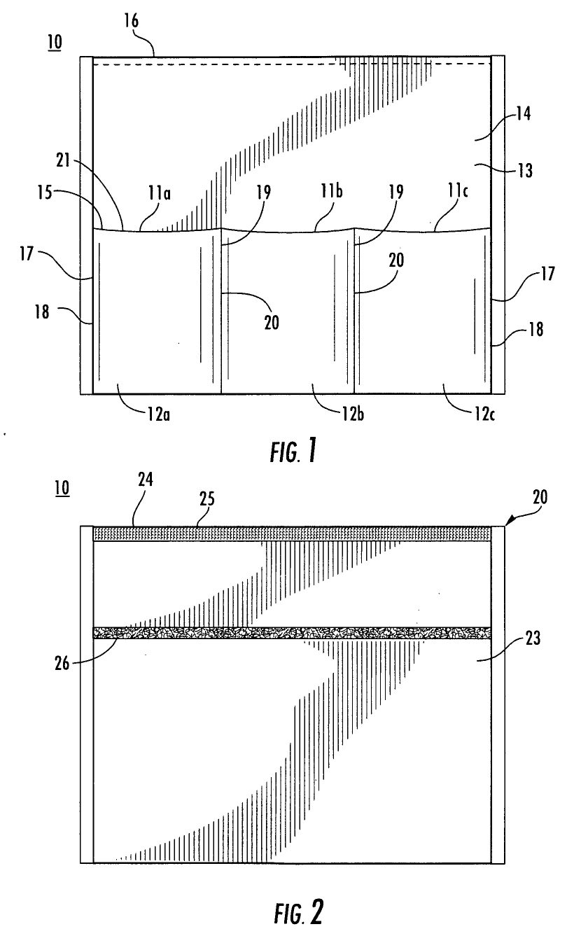

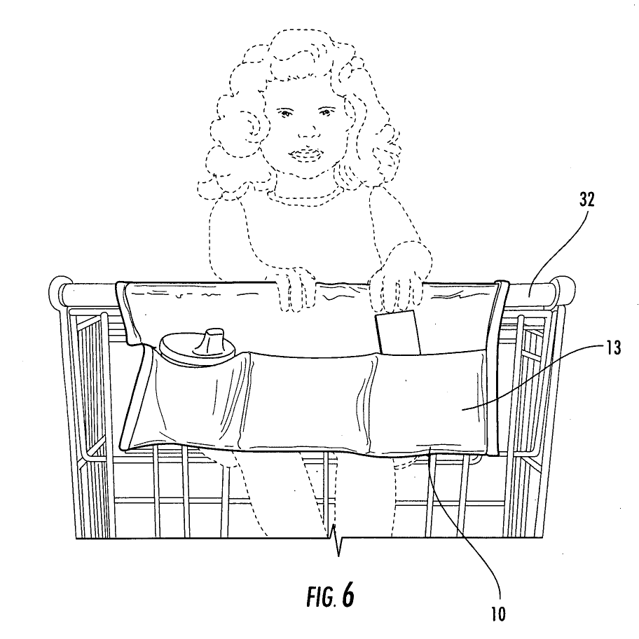

FIGS. 1-6 illustrate sanitary shopping cart organizer device 10 in accordance with the teachings of the present invention. One or more pockets 12A-12C are formed on front surface 13 of device 10, as shown in FIG. 1. Device 10 can be formed of a fabric or plastic material. A suitable material can be a backpack material, such as polyurethane coated, air treated, nylon fabric, such as CORDURA® nylon manufactured by DuPont, KODURA® nylon manufactured by Kolon International Corporation, Korea, and other ripstop nylon fabrics, polyester, and the like. The material can include a coating to provide waterproofing or wiping down of liquids or dirt from the material. The material can be durable and/or indestructible. In one embodiment, a machine washable fabric is used to allow device 10 to be sanitized by machine washing and drying after use. Alternatively, a plastic material can be sanitized with cleaning products.

In one embodiment, device 10 is formed of a single piece of fabric 14. End 15 of fabric 14 is folded towards end 16. End 15 overlaps body 21 of fabric 14. Stitching 17 is provided at edges 18 of fabric 14 for forming a seam. Additional stitching 19 is provided along lines 20 for forming pockets 12a-12c having respective openings 11a-11c.

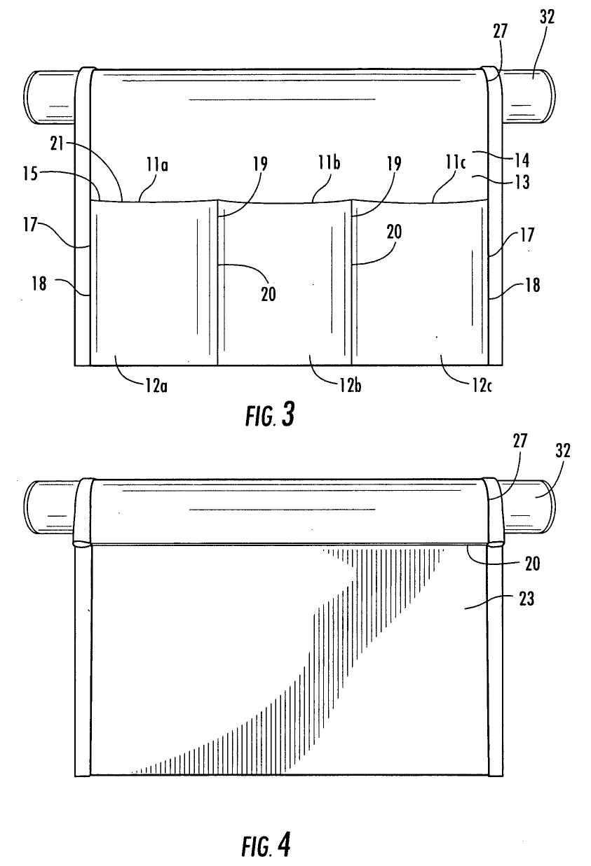

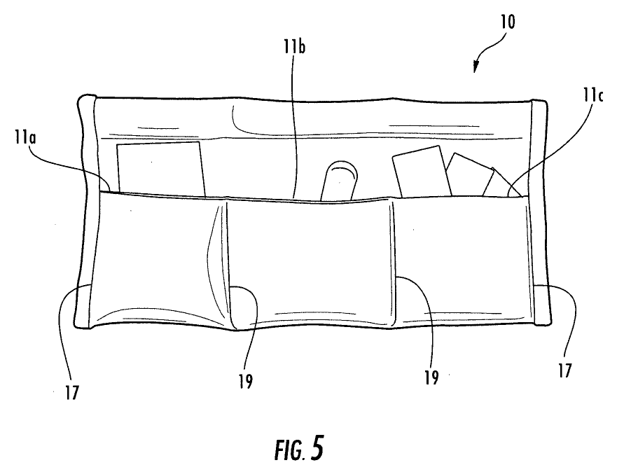

Attachment means 20 is secured to rear surface 23 of device 10. For example, attachment means can be a hook and loop or VELCRO® material. In one embodiment, strip 24 of VELCRO® material is positioned at top end 25 of rear surface. Strip 26 is positioned at a predetermined distance away from top end 25 such that upon attachment of strip 24 to strip 26 cavity 27 is formed as shown in FIGS. 3 and 4. Cavity 27 has sufficient size for receiving and wrapping around shopping cart handle 32 thereby attaching sanitary shopping cart organizer device 10 to handle 32.

Device 10 can have a width W₁ substantially the same as W₂ of shopping chart handle 32. For example, width W₁ can be about 18 inches. Pocket 12 can have a sufficient depth for receiving desired objects. For example, depth D₁ can be about five inches. Length L₁ can be of a sufficient length L₁ for allowing folding over of top end 25. For example, length L₁ can be about 13 inches. In one embodiment, strip 24 is positioned about three inches from strip 26 to provide a sufficient size of cavity 27 for wrapping over handle 32.

Device 10 can be folded into a component shape for easy travelability. For example, device 10 can be folded along lines 20 for reducing the width of device 10.

It is to be understood that the above-described embodiments are illustrative of only a few of the many possible specific embodiments, which can represent applications of the principles of the invention. Numerous and varied other arrangements can be readily devised in accordance with these principles by those skilled in the art without departing from the spirit and scope of the invention.

What is claimed is:

1. A shopping cart organizer for mounting to a handle of a shopping cart comprising:
a device having a front surface;
one or more pockets formed on said front surface; and
attachment means secured to a rear surface of said device, said attachment means including a first attachment means and a second attachment means, a cavity being formed between said first attachment means and said second attachment means adapted for wrapping around a handle of the shopping cart.

2. The shopping cart organizer of claim 1 wherein said device is formed of a single piece of fabric, having a first end folded over a body of said fabric to form a folded section, a seam formed at either edge of said fabric along the folded section and stitching provided along vertical lines of the folded body of the fabric for forming said pockets.

3. The shopping cart organizer of claim 2 wherein said fabric is a durable material.

4. The shopping cart organizer of claim 2 wherein said fabric is formed of a backpack material.

5. The shopping cart organizer of claim 2 wherein said material is selected from polyurethane coated nylon or polyester.

6. The shopping cart organizer of claim 2 wherein said material further comprises a waterproof coating.

7. The shopping cart organizer of claim 1 wherein said first attachment means is a strip of hook and loop material positioned at a top end of said rear surface and said second attachment means is a strip of a hook and loop material positioned a predetermined distance from said top end of said rear surface.

8. The shopping cart organizer of claim 2 wherein said device has a width W₁ substantially the same as the width W₂ of the shopping cart handle.

9. The shopping cart organizer of claim 2 wherein a depth of said pocket is sufficient for receiving desired objects.

10. The shopping cart organizer of claim 2 wherein three pockets are formed on said front surface.

11. The shopping cart organizer of claim 2 wherein said device is foldable along said vertical lines for reducing the width of said organizer.

12. A method for making a shopping cart organizer comprising:
providing a single piece of fabric;
folding a front end of said fabric over a body of said fabric to form a folded section;
forming a seam at either edge of said fabric along the folded section;
stitching one or more vertical lines in said folded section for forming pockets; and
securing an attachment means to a rear surface of said fabric, said attachment means including a first attachment means and a second attachment means, a cavity being formed between said first attachment means and said second attachment means adapted for wrapping around a handle of the shopping cart.

13. The shopping cart organizer of claim 12 wherein said fabric is a durable material.

14. The shopping cart organizer of claim 12 wherein said material is selected from polyurethane coated nylon or polyester.

15. The shopping cart organizer of claim 12 wherein said material further comprises a waterproof coating.

16. The shopping cart organizer of claim 12 wherein said first attachment means is a strip of hook and loop material positioned at a top end of said rear surface and said second attachment means is a strip of a hook and loop material positioned a predetermined distance from said top end of said rear surface.

17. The shopping cart organizer of claim 12 wherein said device has a width W₁ substantially the same as the width W₂ of the shopping cart handle.

18. The shopping cart organizer of claim 12 wherein a depth of said pocket is sufficient for receiving desired objects.

19. The shopping cart organizer of claim 12 wherein three pockets are formed in said front surface.
